(19) United States
(12) Patent Application Publication
(10) Pub. No.: US 2019/0384399 A1
(43) Pub. Date: Dec. 19, 2019

(54) PIEZOELECTRIC DISPLACEMENT AMPLIFICATION APPARATUS

(71) Applicant: Immersion Corporation, San Jose, CA (US)

(72) Inventors: Simon FOREST, Montreal (CA); Vahid KHOSHKAVA, Laval (CA); Neil T. OLIEN, Montreal (CA); Juan Manuel CRUZ-HERNANDEZ, Westmount (CA)

(21) Appl. No.: 16/010,367

(22) Filed: Jun. 15, 2018

(51) Int. Cl. G06F 3/01; B06B 1/06

(52) U.S. Cl. CPC G06F 3/016; B06B 1/0666

(57) ABSTRACT

An actuator system configured to generate a haptic effect is provided. The actuator system includes a cavity configured to store an incompressible fluid, the cavity being disposed within a first substrate, a piezoelectric actuator disposed within a second substrate, and a diaphragm disposed between the cavity of the first substrate and the piezoelectric actuator of the second substrate.

### FIELD OF INVENTION

The embodiments of the present invention generally relate to haptic feedback, and more particularly to systems and methods for haptic feedback using piezoelectric actuators.

### BACKGROUND

Electronic device manufacturers strive to produce a rich interface for users. Conventional devices use visual and auditory cues to provide feedback to a user. In some interface devices, kinesthetic feedback (e.g., active and resistive force feedback) and/or tactile feedback (e.g., vibration, texture, and heat) is also provided to the user, more generally known collectively as “haptic feedback” or “haptic effects.” Haptic feedback can provide cues that enhance and simplify the user interface. Specifically, vibration effects, or vibrotactile haptic effects, may be useful in providing cues to users of electronic devices to alert the user to specific events, or provide realistic feedback to create greater sensory immersion within a simulated or virtual environment.

Piezoelectric actuators may offer advantages over conventional actuators. However, many piezoelectric actuators have small displacements that limit the types of haptic feedback provided. Accordingly, there is a need for techniques that extend the usage of piezoelectric actuators.

### SUMMARY OF THE INVENTION

Embodiments of the present invention are directed toward electronic devices configured to produce haptic effects that substantially improve upon the related art.

Features and advantages of the embodiments are set forth in the description which follows, or will be apparent from the description, or may be learned by practice of the invention.

In one example, an actuator system is configured to generate a haptic effect. The actuator system comprises a cavity configured to store an incompressible fluid, the cavity being disposed within a first substrate, a piezoelectric actuator disposed within a second substrate; and a diaphragm disposed between the cavity of the first substrate and the piezoelectric actuator of the second substrate.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 is a block diagram of a haptically-enabled system/device according to an example embodiment of the present invention.

FIG. 2 illustrates a cross-sectional view of a piezoelectric actuator suitable for use with the embodiments of the present invention.

FIG. 3 illustrates a cross-sectional view of a fluid amplification mechanism for amplifying the displacement of a piezoelectric actuator according to an example embodiment of the present invention.

FIG. 4 illustrates a perspective view of a fluid amplification mechanism for amplifying the displacement of a piezoelectric actuator according to an example embodiment of the present invention.

FIG. 5A illustrates a perspective view of a mechanical amplification mechanism 500 for amplifying the vibration of a piezoelectric actuator according to an example embodiment of the present invention.

FIG. 5B illustrates a top view of a mechanical amplification mechanism 500 for amplifying the vibration of a piezoelectric actuator according to an example embodiment of the present invention.

### DETAILED DESCRIPTION

Reference will now be made in detail to the embodiments, examples of which are illustrated by the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

For many piezoelectric actuators, the displacements provided are very small. The displacements of piezoelectric actuators are typically in the micrometer range, for example. This drawback of piezoelectric actuators has limited their usage because piezoelectric actuators cannot be used to generate significant vibration in an electronic device, such as a smartphone.

By contrast, a typical linear resonance actuator (LRA) utilizes a small moving mass, typically less than one (1) gram, and moves the small moving mass very quickly. However, LRA type actuators typically have a displacement within the millimeter range (i.e., 1000× greater displacement than piezoelectric actuators). In other words, the motion of the moving mass in an LRA type actuator has a displacement that is an order of magnitude 1000 times larger than the corresponding displacement of piezoelectric actuators. Using known techniques, usage of piezoelectric actuators is limited. For example, to achieve an acceleration force equivalent to an LRA type actuator, the moving mass coupled to the piezoelectric actuator would need to be a 1000 times larger. In the smartphone example, the moving mass would need to be about the same size as the smartphone device itself (e.g., 100 grams).

Accordingly, the embodiments of the present invention use mechanical leveraging mechanisms to amplify the displacement of the piezoelectric actuators to achieve high amplitude acceleration (e.g., 1.5 Gpp, 2 Gpp, 3 Gpp, or 5 Gpp) and to generate vibrotactile haptic effects. Example leveraging mechanisms include a fluid mechanism, a lever mechanism, a pulley or gear mechanism, or the like. In addition, the embodiments of the present invention use mechanical leverage to amplify the piezoelectric displacement from the micrometer range to the millimeter range. As a result, the embodiments may utilize a moving mass of similar size to the moving mass used by LRA type actuators. In addition, the amplified actuators of the embodiments can be faster and/or higher definition (“HD) type actuators, as compared to LRA type actuators.

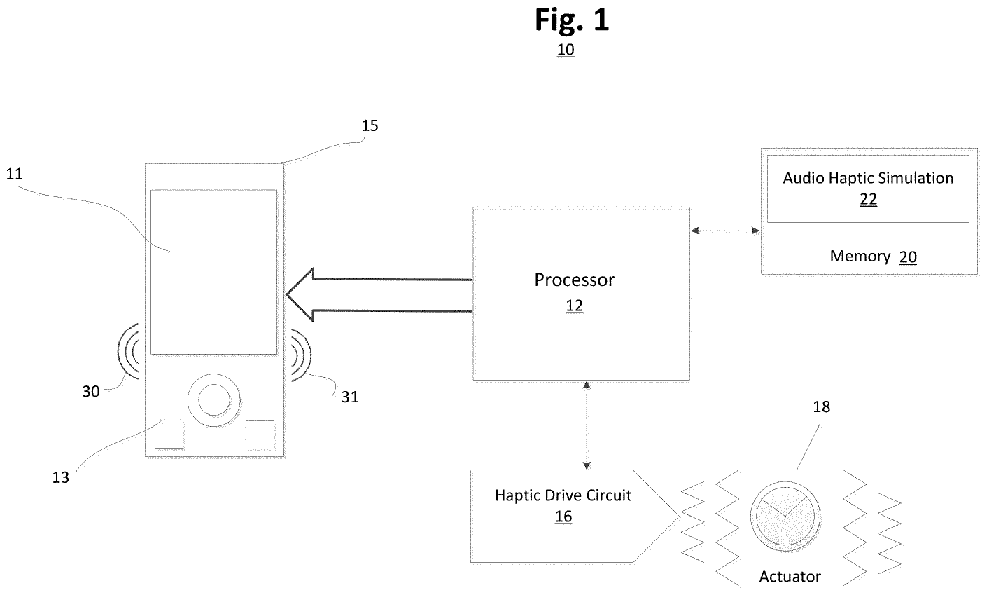

FIG. 1 is a block diagram of a haptically-enabled system/device 10 according to an example embodiment of the present invention. System 10 includes a touch sensitive surface 11 or other type of user interface mounted within a housing 15, and may include mechanical keys/buttons 13.

Internal to system 10 is a haptic feedback system that generates haptic effects on system 10 and includes a processor or controller 12. Coupled to processor 12 is a memory 20, and a haptic drive circuit 16 which is coupled to a piezoelectric actuator 18. Processor 12 may be any type of general purpose processor, or could be a processor specifically designed to provide haptic effects, such as an application-specific integrated circuit (“ASIC”). Processor 12 may be the same processor that operates the entire system 10, or may be a separate processor. Processor 12 can decide what haptic effects are to be played and the order in which the effects are played based on high level parameters. In general, the high level parameters that define a particular haptic effect include magnitude, frequency and duration. Low level parameters such as streaming motor commands could also be used to determine a particular haptic effect. A haptic effect may be considered “dynamic” if it includes some variation of these parameters when the haptic effect is generated or a variation of these parameters based on a user's interaction. The haptic feedback system in one embodiment generates vibrations 30, 31 or other types of haptic effects on system 10.

Processor 12 outputs the control signals to haptic drive circuit 16, which includes electronic components and circuitry used to supply piezoelectric actuator 18 with the required electrical current and voltage (i.e., “motor signals”) to cause the desired haptic effects. System 10 may include more than piezoelectric actuator 18 actuator 18 as well as other actuator types, and each actuator may include a separate drive circuit 16, all coupled to a common processor 12.

Haptic drive circuit 16 is configured to generate one or more haptic drive signals. For example, the haptic drive signal may be generated at and around the resonance frequency (e.g., +/−20 Hz, 30 Hz, 40 Hz, etc.) of piezoelectric actuator 18. In certain embodiments, haptic drive circuit 16 may comprise a variety of signal processing stages, each stage defining a subset of the signal processing stages applied to generate the haptic command signal.

Non-transitory memory 20 may include a variety of computer-readable media that may be accessed by processor 12. In the various embodiments, memory 20 and other memory devices described herein may include a volatile and nonvolatile medium, removable and non-removable medium. For example, memory 20 may include any combination of random access memory (“RAM”), dynamic RAM (“DRAM”), static RAM (“SRAM”), read only memory (“ROM”), flash memory, cache memory, and/or any other type of non-transitory computer-readable medium. Memory 20 stores instructions executed by processor 12. Among the instructions, memory 20 includes audio haptic simulation module 22, which are instructions that, when executed by processor 12, generates high bandwidth haptic effects using speaker 28 and piezoelectric actuator 18, as disclosed in more detail below. Memory 20 may also be located internal to processor 12, or any combination of internal and external memory.

System 10 may be any type of handheld/mobile device, such as a cellular telephone, personal digital assistant (“PDA”), smartphone, computer tablet, gaming console, controller or split controller, remote control, or any other type of device that includes a haptic effect system that includes one or more actuators. System 10 may be a wearable device such as wristbands, headbands, eyeglasses, rings, leg bands, arrays integrated into clothing, etc., or any other type of device that a user may wear on a body or can be held by a user and that is haptically enabled, including furniture or a vehicle steering wheel. Further, some of the elements or functionality of system 10 may be remotely located or may be implemented by another device that is in communication with the remaining elements of system 10.

The embodiments of the present invention are generally directed to piezoelectric actuators. Many types of piezoelectric actuators may be used. For example, in some embodiments, piezoelectric actuator 18 may comprise a ceramic or monolithic piezoelectric actuator. In other embodiments, piezoelectric actuator 18 may comprise a composite piezoelectric actuator. Additionally, or alternatively, piezoelectric actuator 18 may be placed in a position where it acts as an elongator, contractor, or bender.

Other actuator types may be included within system 10. In general, an actuator is an example of a haptic output device, where a haptic output device is a device configured to output haptic effects, such as vibrotactile haptic effects, electrostatic friction haptic effects, temperature variation, and/or deformation haptic effects, in response to a drive signal. Actuator types include, for example, an electric motor, an electro-magnetic actuator, a voice coil, a shape memory alloy, an electro-active polymer, a solenoid, an eccentric rotating mass motor (“ERM”), a harmonic ERM motor (“HERM”), a linear resonance actuator (“LRA”), a solenoid resonance actuator (“SRA”), a piezoelectric actuator, a macro fiber composite (“MFC”) actuator, a high bandwidth actuator, an electroactive polymer (“EAP”) actuator, an electrostatic friction display, an ultrasonic vibration generator, or the like. In some instances, the actuator itself may include a haptic drive circuit. In the description that follows, a piezoelectric actuator may be used as an example, but it should be understood that the embodiments of the present invention may be readily applied to other types of actuator or haptic output devices.

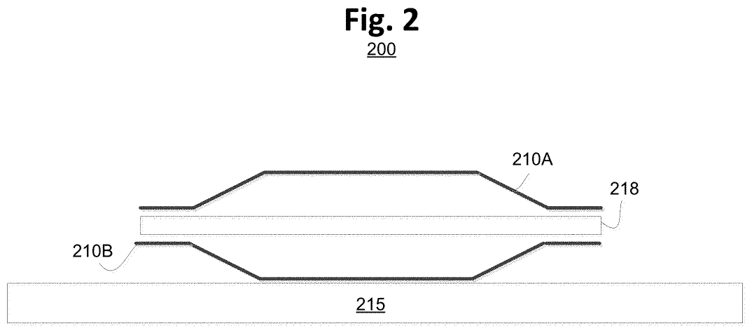

FIG. 2 illustrates a cross-sectional view of a piezoelectric actuator 200 suitable for use with the embodiments of the present invention.

As illustrated in FIG. 2, piezoelectric actuator 200 includes piezo-ceramic material 218 disposed between first cymbal 210A and second cymbal 210B. In some instances, piezoelectric actuator 200 may be mounted to a mechanical ground 215, such as the housing of the host electronic device, such as a smartphone. Each of first and second cymbals 210A, 210B may have a circular and/or dome-like shape, but a variety of configurations are feasible. In addition, each of first and second cymbals 210A, 210B may be physically coupled to piezo-ceramic material 218 using one or more adhesive layers (not shown), for example. Two or more electric contacting pads (now shown) may be configured to electrically drive piezoelectric actuator 200.

Piezoelectric actuator 200 may comprise a variety of commercially available piezoelectric actuators, such as TDK's Miniaturized PowerHap 2.5G. For example, this particular piezoelectric actuator has compact dimensions of 9 mm by 9 mm, thickness of 1.25 millimeters, produces a force of 5N, has high acceleration of 2.5G (under predetermined measurement conditions), and has a relatively large displacement of 35 μm.

As discussed above, commercially available piezoelectric actuators do not provide significant vibration for a portable electronic device, such as a smartphone. As further discussed above, the main reason is the displacement characteristic, which is quite small (i.e., 35 μm). By contrast, commercially available LRA type actuators typically have a much larger displacement, such as 1 mm, for example.

In the discussion that follows, the various embodiments are directed to fluid and mechanical leveraging mechanisms configured to amplify the displacement of the piezoelectric actuators. By implementing the various embodiments, high amplitude acceleration may be provided for vibrotactile haptic effects. In addition, the various leveraging mechanisms are configured to increase the displacement of the piezoelectric actuators, for example from 35 μm to 1 mm.

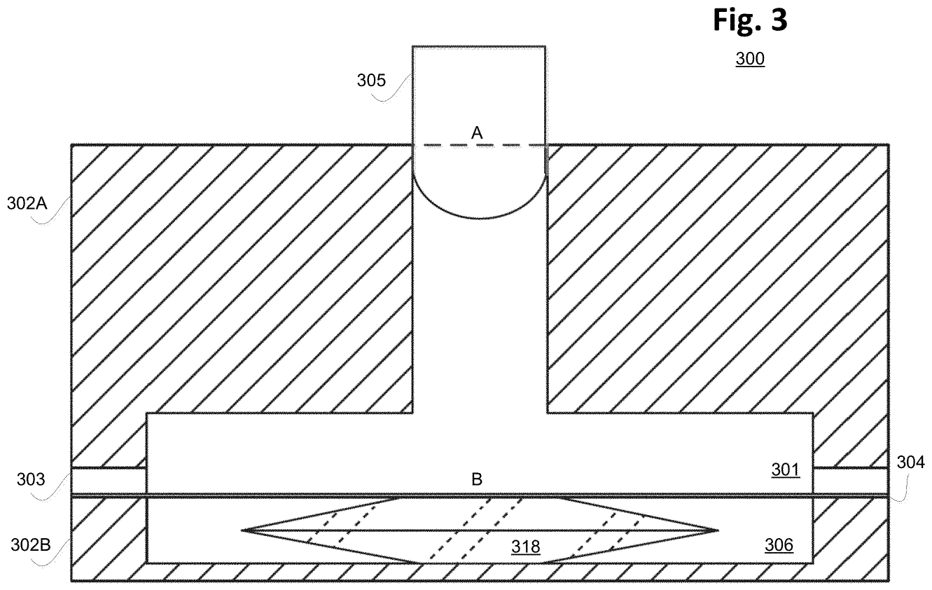

FIG. 3 illustrates a cross-sectional view of a fluid amplification mechanism 300 for amplifying the displacement of a piezoelectric actuator 318 according to an example embodiment of the present invention.

As illustrated in FIG. 3, fluid amplification mechanism 300 includes cavity 301, first substrate 302A, second substrate 302B, silicone gasket layer 303, diaphragm 304, plunger 305, actuator pocket 306, and piezoelectric actuator 318.

Cavity 301 is configured to store an incompressible fluid (i.e., a fluid with a low factor of compressibility, such as various commercially available oils or other heavy liquids). In some instances, oil is preferred to water because of its higher viscosity which provides better support for a driving component received at an opening surface A. For example, a driving component, such as plunger 305, may be received and driven at opening surface A. Although cavity 301 is depicted as having a T-shape, having an upper opening surface A and a lower closed surface B, other configurations are feasible. In the various configurations, the diameter of surface A is smaller than the diameter of surface B.

First substrate 302A is configured to form cavity 301. In other words, cavity 301 is formed within first substrate 302A. Second substrate 302B is configured to house piezoelectric actuator 318 within an actuator pocket 306. In other words, actuator pocket 306 is formed within second substrate 302B, and piezoelectric actuator 318 is disposed therein. First and second substrates 302A, 302B may be formed of a variety of lightweight materials, such as acrylic or other plastics.

Actuator pocket 306 may be slightly larger than piezoelectric actuator 318. For example, a 9 mm diameter piezoelectric actuator 318 may be disposed within a 12.67 mm diameter actuator pocket 306. However, the depth of actuator pocket 306 (e.g., 1.2 mm) may be slightly reduced as compared to than the height of piezoelectric actuator 318 (e.g., 1.25 mm). The reduced depth may be configured to create a slight compression on piezoelectric actuator 318 to hold it in place between second substrate 302B and diaphragm 304. Alternatively, or additionally, piezoelectric actuator 318 may be otherwise coupled or physically joined to second substrate 302A and/or diaphragm 304. For example, one or more adhesives may be used.

Silicone gasket layer 303 is a sealant material configured to seal the interface between first substrate 302A and diaphragm 304. Silicone gasket layer 303 ensures that fluid does not leak from cavity 301.

Diaphragm 304 is a thin diaphragm layer that may be composed of a variety of flexible materials, such as a steel sheet or plastic layer. For example, diaphragm 304 may be a steel sheet having a thickness of 0.0635 mm (i.e., 0.0025 in). The stiffness of diaphragm 304 may be varied by changing the diaphragm material or applying a pre-tension to tune the resonance frequency of piezoelectric actuator 318.

Plunger 305 may be a rod shaped structure or driving component configured to drive a moving mass. For example, plunger 305 may drive a moving mass directly or through an advantageous mechanical assembly, such as a lever mechanism, pulley or gear mechanism, or the like.

An example structure of piezoelectric actuator 318 is described in connection with FIG. 2 (e.g., piezoelectric actuator 200 of FIG. 2). As discussed above, piezoelectric actuator 318 may be selected from commercially available piezoelectric actuators.

When actuated, piezoelectric actuator 318 may exert force or push on diaphragm 304. As a result, diaphragm 304 may be deformed and a volume displacement of the fluid in cavity 301 may be generated. In turn, the volume displacement of the fluid in cavity 301 drives plunger 305. Here, the displacement into cavity 301, by diaphragm 304, equals the displacement out of cavity 301 at surface A. For the incompressible fluid in cavity 301, the fluid has constant density and a constant volume. Additionally, because the diameter of surface A of cavity 301 is smaller than the diameter of surface B of cavity 301, the fluid moves toward surface A with greater amplitude when surface B is driven by diaphragm 304. The ratio of fluid movement between surfaces A and B is the leveraging amplification or leveraging ratio. Accordingly, the diameters of surfaces A and B may be varied to achieve the desired leveraging amplification (e.g., 30 times).

To achieve a leveraging amplification of 30 times, the diameter of surface B may be five to six times the diameter of surface A (e.g., a ratio of 5.5). Here, the diameter of surface B may be 13 mm and the diameter of surface A may be 2.4 mm, for example.

In the various embodiments plunger 305 may be a standalone components or may comprise, or be otherwise coupled to, other components of the host electronic device, such as a push button, rotatable knob, screen, touchscreen, digital crown, and the like.

Accordingly, fluid amplification mechanism 300 may be configured to achieve significant leveraging amplification. Additionally, fluid amplification mechanism 300 is operable to provide haptic effects of similar magnitude to an LRA type actuator.

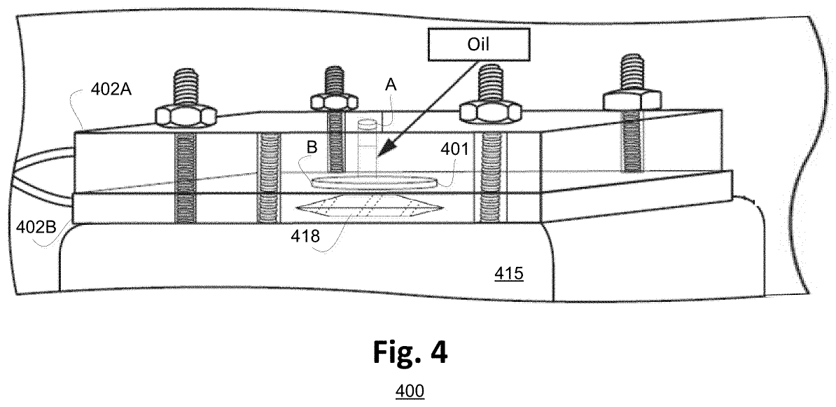

FIG. 4 illustrates a perspective view of a fluid amplification mechanism 400 for amplifying the displacement of a piezoelectric actuator 418 according to an example embodiment of the present invention.

As shown in FIG. 4, fluid amplification mechanism 400 includes cavity 401, first substrate 402A, second substrate 402B, and piezoelectric actuator 418. Although not expressly shown in this perspective view, other components such as the silicone gasket layer, diaphragm, and plunger which are described in connection with FIG. 3, also comprise fluid amplification mechanism 400. Additionally, actuator 418 may be disposed within the actuator pocket of second substrate 402B. The various components of fluid amplification mechanism 400, and its operation, have been described in connection with FIG. 3.

As discussed above, an incompressible fluid, such as oil or other heavy liquids, is contained within cavity 401 to provide support for a driving component, such as a plunger, that may be received at an opening surface A. In the various configurations, the diameter of surface A is smaller than the diameter of surface B.

Here, fluid amplification mechanism 400 is depicted on a mechanical ground 415, such as the housing or another component of a smartphone. Although mechanical ground 415 is depicted as a single element, multiple mechanically coupled elements may collectively form mechanical ground 415. In addition, a plurality of screws and nuts are depicted to physically join the various components of fluid amplification mechanism 400, however, other coupling mechanisms also may be used.

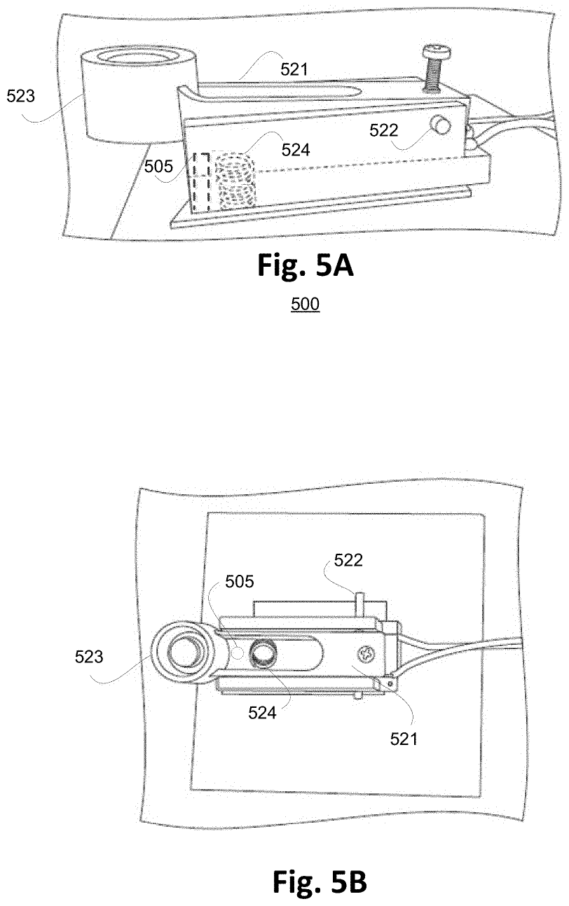

FIG. 5A illustrates a perspective view of a mechanical amplification mechanism 500 for amplifying the vibration of a piezoelectric actuator according to an example embodiment of the present invention. FIG. 5B illustrates a top view of a mechanical amplification mechanism 500 for amplifying the vibration of a piezoelectric actuator according to an example embodiment of the present invention.

As illustrated in FIGS. 5A and 5B, mechanical amplification mechanism 500 includes lever 521, fulcrum point 522, moving mass 523, and tension spring 524. Lever 521 and/or moving mass 523 are configured to be driven by driving component 505, such as plunger 305 of FIG. 3. Although plunger 505 is depicted here, the plunger drive mechanism (e.g., fluid amplification mechanism 300 of FIG. 3) has been omitted from this view. Additionally, tension spring 524 may be configured to return lever 521 and/or moving mass 523 to a desired resting or un-driven position.

According to a preferred embodiment, driving component 505 is driven by a piezoelectric actuator, such as piezoelectric actuator 200 of FIG. 2. However, driving component 505 also may be driven by other actuator types, such as the various haptic output devices discussed in connection with FIG. 1.

By placing component 505 at an opposite distal side as compared to fulcrum point 522, the amount of force used to drive moving mass 523 is greatly reduced. Although the depicted embodiment utilizes a lever mechanism, such as lever 521, the moving mass may also be driven by other mechanically advantageous mechanisms, such as pulley mechanisms, gearing mechanisms, or the like. Additionally, or alternatively, a multi-actuator mechanical mechanism may utilize piezoelectric actuators on opposite sides of fulcrum point 522. In the various embodiments, there may be a tradeoff between the displacement of moving mass 523 and the output force of moving mass 523.

In the various embodiments moving mass 523 may be a standalone components or may comprise, or be otherwise coupled to, other components of the host electronic device, such as a push button, rotatable knob, screen, touchscreen, digital crown, and the like.

One having ordinary skill in the art will readily understand that the invention as discussed above may be practiced with steps in a different order, and/or with elements in configurations which are different than those which are disclosed. Additionally, one of ordinary skill in the art will readily understand that features of the various embodiments may be practiced in various combinations. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An actuator system configured to generate a haptic effect, the actuator system comprising:
a cavity configured to store an incompressible fluid, the cavity being disposed within a first substrate;
a piezoelectric actuator disposed within a second substrate; and
a diaphragm disposed between the cavity of the first substrate and the piezoelectric actuator of the second substrate.

2. The actuator system according to claim 1, further comprising a silicone gasket layer configured to seal the interface between the first substrate and the diaphragm.

3. The actuator system according to claim 1, wherein the incompressible fluid is an oil.

4. The actuator system according to claim 1, further comprising:
a plunger that is disposed at an opening surface of the cavity.

5. The actuator system according to claim 1, wherein a first diameter of an opening surface of the cavity is smaller than a second diameter of a closed surface of the cavity.

6. The actuator system according to claim 1, wherein the piezoelectric actuator is disposed within an actuator pocket of the second substrate, the actuator pocket having a depth that is smaller than the height of the piezoelectric actuator.

7. The actuator system according to claim 1, wherein when the piezoelectric actuator is actuated, an exerted force causes a deformation of the diaphragm into the cavity.

8. The actuator system according to claim 7, wherein the deformation causes movement of the incompressible fluid, the movement being configured to drive a plunger disposed at an opening surface of the cavity.

9. The actuator system according to claim 8, wherein the plunger is configured to drive a moving mass that is coupled to a lever or other mechanical assembly.

10. The actuator system according to claim 8, wherein the plunger is configured to drive a user-input element of an electronic device.

11. The actuator system according to claim 1, wherein the piezoelectric actuator includes a piezo-ceramic material disposed between to cymbal structures.

12. The actuator system according to claim 1, wherein a stiffness value of the diaphragm is determined according to the resonance frequency of the piezoelectric actuator.

13. A method for providing an actuator system configured to generate a haptic effect, the method comprising:
providing within a first substrate a cavity configured to store an incompressible fluid;
providing a piezoelectric actuator disposed within a second substrate; and
providing a diaphragm disposed between the cavity of the first substrate and the piezoelectric actuator of the second substrate.

14. The method for providing the actuator system according to claim 13, further comprising:
providing a silicone gasket layer configured to seal the interface between the first substrate and the diaphragm.

15. The method for providing the actuator system according to claim 13, wherein the incompressible fluid is an oil.

16. The method for providing the actuator system according to claim 13, further comprising a plunger that is disposed at an opening surface of the cavity.

17. The method for providing the actuator system according to claim 13, wherein a first diameter of an opening surface of the cavity is smaller than a second diameter of a closed surface of the cavity.

18. The method for providing the actuator system according to claim 13, wherein the piezoelectric actuator is disposed within an actuator pocket of the second substrate, the actuator pocket having a depth that is smaller than the height of the piezoelectric actuator.

19. The method for providing the actuator system according to claim 13, wherein when the piezoelectric actuator is actuated, an exerted force causes a deformation of the diaphragm into the cavity.

20. The method for providing the actuator system according to claim 19, wherein the deformation causes movement of the incompressible fluid, the movement being configured to drive a plunger disposed at an opening surface of the cavity.
